(19) United States
(12) Patent Application Publication
(10) Pub. No.: US 2011/0135131 A1
(43) Pub. Date: Jun. 9, 2011

(54) FLEXIBLE CONNECTOR FOR HEARING DEVICE

(75) Inventor: Keld Winther, Sabro (DK)

(73) Assignee: ESTRON A/S, Them (DK)

(21) Appl. No.: 12/738,262

(22) PCT Filed: Oct. 16, 2007
(86) PCT No.: PCT/DK2007/000443

§ 371 Date: Sep. 15, 2010

(51) Int. Cl. H04R 25/00

(52) U.S. Cl. 381/322

(57) ABSTRACT

This invention relates to a connector to be mounted between the receiver and the ear side unit of a hearing device, wherein said connector is flexible and comprises at least one stiff section shaped for maintaining the positioning of at least a part of said hearing device at or near the user's ear. An isolated wire could be used as the soft and flexible part of the connector. Said isolated wire comprises a number of lacquered conducting wires, a strength fiber and a flexible outer isolating jacket. The lacquered conducting wires and the tensile strength fiber are twisted together such that they form a helix that constitutes the core part of the isolated wire.

### FIELD OF THE INVENTION

The present invention relates to connectors for connecting the ear side unit and receiver of a hearing device.

### BACKGROUND OF THE INVENTION

Headsets and hearing devices often comprise an ear side unit placed behind the ear and a receiver (loudspeaker) placed in or near the ear channel. The ear side unit comprises, in connection with hearing devices, a number of microphones for detecting sounds and data handling and amplifier units for data handling and amplification of the sound signals recorded by the microphone. The data handled and amplified sound signals are hereafter transmitted to the receiver through lead wires drawn from the ear side unit to the receiver where the sound signals would be converted into sound waves inside the ear channel and thereby improving the user's listening skills. In connection with headsets instead of microphones, the ear side unit could for instance comprise a radio receiver for receiving sound signals transmitted as radio waves (FM, AM, Bluetooth, etc.) and thereby enable the user to receive and hear sound signals transmitted as radio signals.

The lead wires connecting the ear side unit and the receiver are today drawn through a sound tube which is mounted directly on the ear and adapted to fixate the ear side unit behind the ear and the receiver in or near the ear channel. As a consequence, the sound tube needs to be relatively stiff in order to secure the ear side unit and the receiver properly. Many people find the relativity stiff sound tube very uncomfortable to wear because it is often impossible to place the sound tube such that it is not annoying. Another issue is the fact that the sound tube is often relatively large and made of a relatively stiff material in order to provide strength to the sound tube. Further, many people want to have a very discreet and comfortable hearing device and find the existing sound tube both indiscreet and annoying to wear. Another aspect is the fact that each lead wire needs to be drawn and/or pushed through the sound tube which is very difficult and time-consuming.

### OBJECT AND SUMMARY OF THE INVENTION

It is an object of the invention to overcome some or all of the above-mentioned problems.

This is achieved by the invention as defined by the independent claims, and other advantageous embodiments of the invention are defined by the dependent claims. The benefits and advantages of the present invention are explained and discussed in the detailed description.

### BRIEF DESCRIPTION OF THE DRAWINGS

In the following, preferred embodiments of the invention will be described referring to the figures, where

FIGS. 1a and 1b illustrate a hearing device comprising a sound tube according to prior art;

FIGS. 2a and 2b illustrate an embodiment of a sound tube according to the present invention;

FIG. 3 illustrates an isolated wire suitable to be used as sound tube;

FIG. 4 illustrates a cross section of an ear of a person wearing a hearing device comprising a connector according to the present invention.

### DESCRIPTION OF EMBODIMENTS

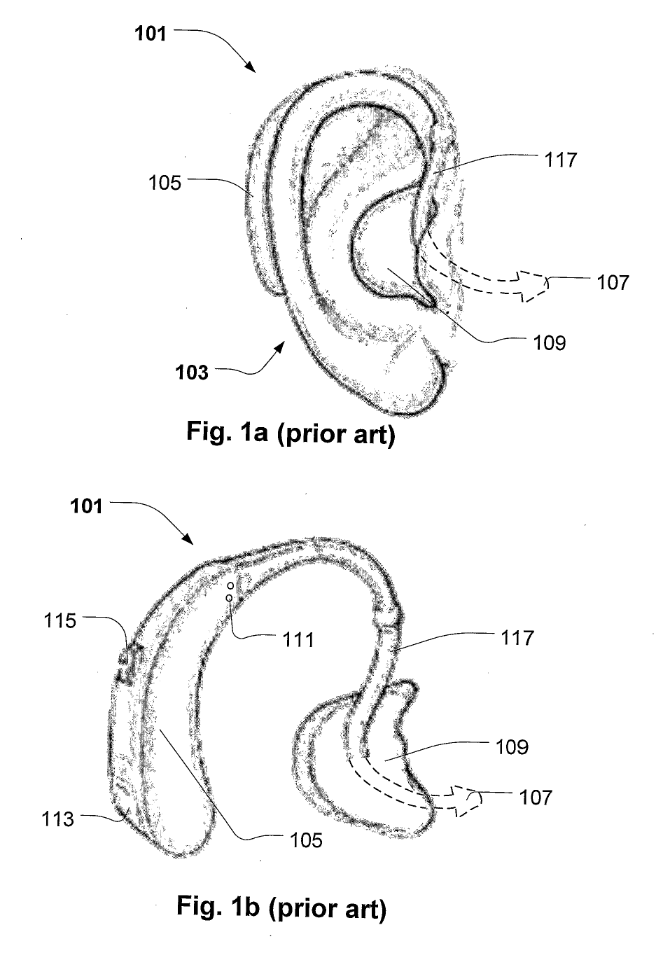

FIGS. 1a and 1b illustrate a hearing device as known in the prior art, where FIG. 1a illustrates how the hearing device (101) is placed on the ear (103) and FIG. 1b illustrates the hearing device without the ear. The hearing device comprises an ear side unit (105) placed behind the ear, a receiver (107) placed within the ear channel (109) or could in other embodiments be placed near the ear channel. The ear side unit comprises a microphone array (111), a battery chamber (113) for power supplying of the hearing device, a volume control (115) enabling the user to turn the volume up and down and processing and amplifying units (not shown since it is enclosed). The microphones record the sound and convert the acoustic signals into electric signals and the processing and amplifying units would hereafter typically filter and amplify the electric signals. The processing and amplifying units could be implemented as analog units, digital units or a combination of both analog and digital units. The ear side unit is through a sound tube (117) connected to the receiver (107) placed in the ear channel. The sound tube comprises a number of lead wires (not shown) drawn through the sound tube, and the lead wires are connected to the processing and amplifying unit at the ear side unit and to the receiver. Thereby the processed and amplified signals could be transmitted from the ear side unit behind the ear to the receiver inside the ear channel, where the receiver converts the electric signals into acoustic signals. The sound tube is made of a relatively stiff material and adapted to fit around the ear (103) and to position the ear side unit behind the ear and the receiver inside the ear channel is illustrated in FIG. 1. Many people find it difficult to position the hearing device such that the sound tube is not annoying, because the tube is made of a relatively hard material and has a relatively large extent. Many people furthermore find the sound tube indiscreet. Another problem with the existing sound tubes is that sound tubes for both the right and left ear need to be produced. Yet another problem with the prior art sound tubes is the fact that the lead wires need to be drawn/pushed through the sound tube individually, which is a very time-consuming process and therefore increases the production costs. Further, when using the prior art sounds tubes there is a possibility that sounds would travel inside the sound tube and result in noise that would reduce the sound quality of the hearing device.

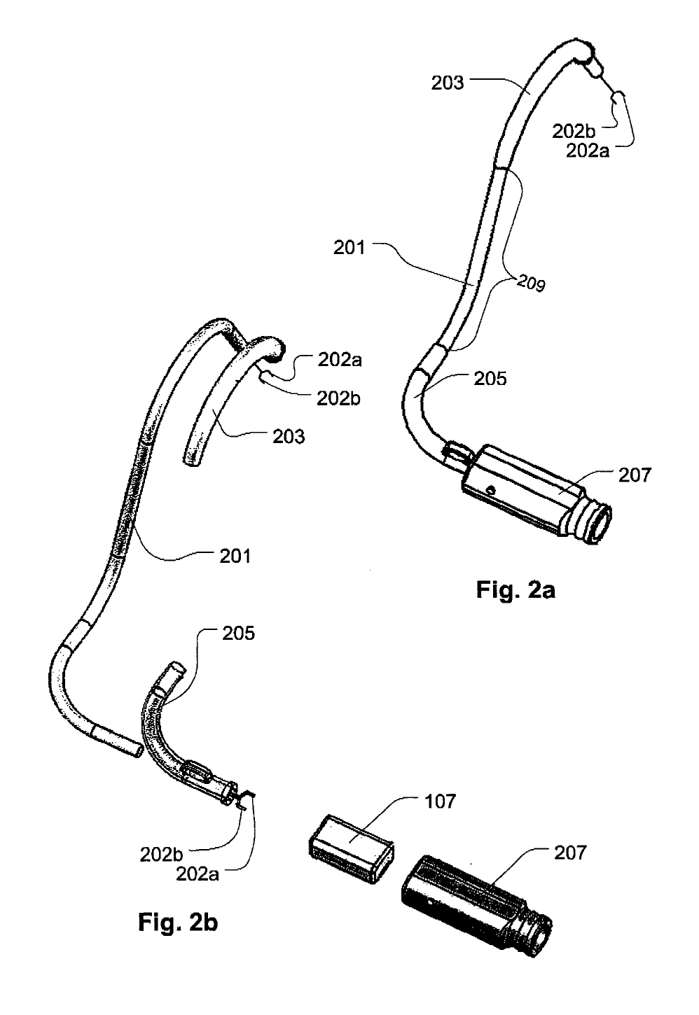

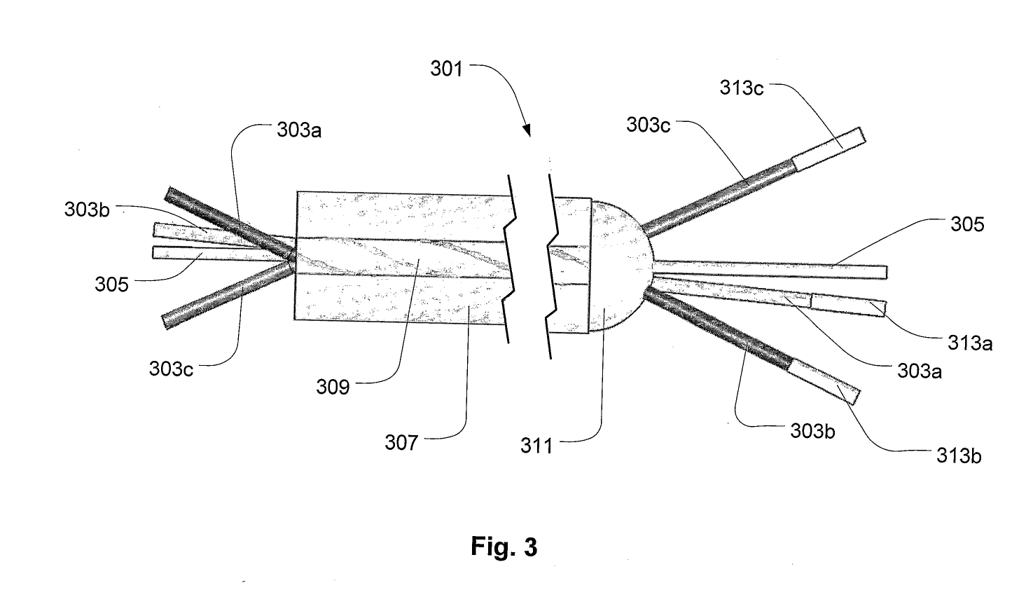

FIG. 2a illustrates an embodiment of a connector (201) according to the present invention where the connector connects the ear side unit (not shown) and the receiver (107) of a hearing device, and FIG. 2b illustrates an exploded view of the same connector. The receiver is in the illustrated embodiment placed in a receiver housing (207) that can be positioned in the user's ear channel. The connector (201) is in this embodiment constructed as an isolated wire (see FIG. 3) comprising a number of twisted lacquered conducting wires (202a, 202b) onto which an outer isolating jacket has been extruded. The connector could in another embodiment alternatively be constructed as a tube made of a soft and flexible material such as for instance PVC, PEB, nylon, Pebax, silicone or the like, where the lead wires are drawn/pushed through the tube. Kevlar could be used in order to improve tensile strength. The ends (202a, 202b) of the twisted lacquered conducting wires can be connected to the receiver (107) and to the ear side unit. The soft and flexible connector (201) comprises in the shown embodiment further an ear side stiffener (203) formed as a stiff tube which is fastened to the ear side unit and shaped as a curve such that it fits around the upper part of the ear helix. The connector (201) is therefore drawn through the ear side stiffener (203) and enters the ear side unit where the lead twisted lacquered wires (202a, 202b) are connected to the electrical means of the ear side unit. The ear side stiffener (203) would therefore be able to fixate the ear side unit behind the ear. The connector further comprises a receiver side stiffener (205) formed as a stiff tube connected to a receiver housing (207) and shaped to fit the entrance of the ear channel such that the receiver housing (207) would be maintained in a position inside the ear channel. The receiver housing (207) surrounds the receiver (107) and the twisted lacquered wires (202a, 202b) enter the receiver housing through the receiver side stiffener (205), and they can thus be connected to the receiver inside the receiver housing.

In sum, the connector comprises an ear side stiffener (203) fixating the ear side unit behind the ear, a receiver side stiffener (205) fixating the receiver housing (207) inside the ear channel and a soft and flexible connector part (209). The connector shown in FIGS. 2a and 2b is very nice to wear due to the fact that the user could position the soft and flexible connector part (209) around his/her ear as he/she pleases, and the connector is further very discreet and could for instance be dyed/painted in skin color. The ear side unit and receiver would due to the stiffeners further be maintained in their proper positions.

FIG. 3 illustrates an isolated wire (301) that could be used as the soft and flexible part of the connector (201). The isolated wire (301) comprises a number of lacquered conducting wires (303a, 303b, 303c), a strength fiber (305) and a flexible outer isolating jacket (307). The lacquered conducting wires (303a, 303b, 303c) and the tensile strength fiber (305) are twisted together such that they form a helix that constitutes the core part (309) of the isolated wire. The stiffness and strength of the isolated wire can be modified to fit different customer specifications by varying the materials and dimensions of the lacquered conducting wires and/or the strength fiber. The strength of the isolated wire could for instance be increased by adding more strength fibers (305), by choosing strength fibers made of strong material and/or by increasing the dimensions of the strength fibers or the lacquered conducting wires. The strength fibers could for instance be aramid fibers, such as Kevlar fibers or other strong synthetic fibers. Each lacquered conducting wire comprises in one embodiment a number of lacquered magnet wires that are twisted together and form a helix. One or more of the magnet wires could be colored and thereby forming a tracer for easy identification of each lacquered conducting wire. The lacquer could for instance be polyamide, polyurethane or the like. By lacquering the magnet wires individually they can be displaced relative to each other and they therefore form a very flexible and soft lacquered wire. The twisted lacquered conducting wires (303a, 303b, 303c) and the strengthen fiber could be secured to the outer jacket (307) by adhesive (311) as illustrated to the right in FIG. 3. The isolated wire is hereby made tight because the adhesive would prevent air, moist and dirt form entering the outer jacket. This improves the isolated wire against corrosion and excludes further sounds from travelling inside the outer jacket. The lacquered conducting wires could further be tinned (313a, 313b, 313c) at their ends such that each lacquered wire could easily be brazed to an electric application (e.g. the ear side unit or receiver) and thereby create a very good contact between the electric application and the isolated wire. Further, the tinned ends ensure that there is an electrical connection between the lacquered magnet wires of each lacquered conducting wire. Electrical signals can then be transmitted through each of the lacquered conducting wires. The lacquered conducting wires are isolated from each other due to the lacquer that covers the conducting part of the lacquered conducting wires. The consequence is that the conducting wires could be isolated from each other without having an outer jacket made of an isolating material such as for instance some kind of polymer around each conducting wire. The outer diameters of the conducting wires are hereby reduced dramatically, and as a result the outer diameter of the isolating wire is reduced even more. The flexibility and softness of the isolated wire is further improved as the relatively inflexible and hard outer jackets presently used around conducting wires are omitted. The strength fiber improves the strength of the isolated wire, and the softness, flexibility and strength of the isolated wire could be designed to specific specifications by choosing the material of the strength fibers, by regulating the dimensions of the strength fibers or by choosing the number of strength fibers integrated into the isolated wire. Another advantage of the present invention is that the isolated wire is less sensitive to noise, e.g. electro mechanical noise, because the lacquered conducting wires are twisted. Further, when using an isolated wire the amount of air in the connection between the receiver and the ear side unit is reduced and consequently acoustic feed back is reduced. Summed up, the isolated conducting wire according to the present invention combines flexibility, softness and strength.

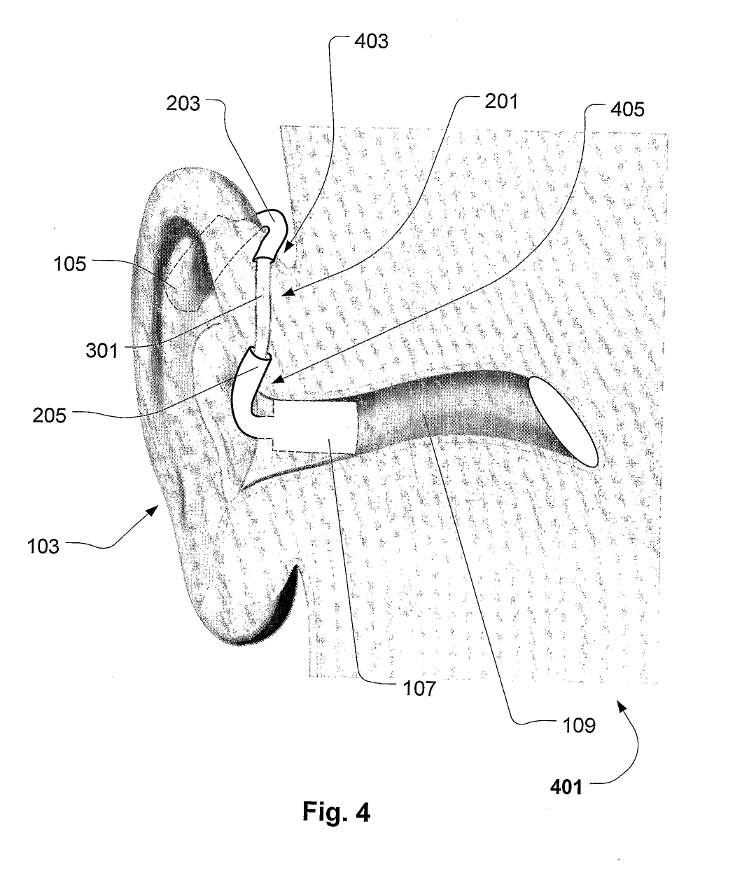

FIG. 4 illustrates a cross section of an ear (103) of a person (401) wearing a hearing device comprising a connector (201) according to the present invention. The connector (201) comprises an isolated wire (301), as described above, connecting the ear side unit (105) and receiver (107). The connector further comprises an ear side stiffener (203) which is shaped as a curve that engages with the upper part of the ear (403) and thus fixates the ear side unit behind the ear. The connector further comprises a receiver side stiffener (205) shaped as a curve which can engage with the entrance side at the ear channel (109). The stiffener portions could in other embodiments be adapted to engage with other parts of the ear, e.g. the helix, the root of the helix, the anti-helix, concha, tragus, anti-tragus, lobule or intertragic notch.

It is to be understood that the illustrated embodiments only serve as illustrating examples rather than limiting the scope of the claims. A person skilled in the art may therefore be able to construct alternative embodiments within the scope of the claims.

1. A connector to be mounted between the receiver and the ear side unit of a hearing device, wherein said connector comprises a flexible part, and at least one stiff section wherein:
part of said flexible part extends through said at least one stiff section; and
said at least one stiff section is a stiff tube shaped as a curve and maintains the positioning of at least a part of said hearing device at or near the user's ear.

2. A connector according to claim 1, wherein said at least one stiff section is shaped as a curve and maintains the position of said ear side unit behind the user's ear.

3. A connector according to claim 1, wherein said at least one stiff section is shaped as a curve and maintains the position of said receiver in or near the user's ear channel.

4. A connector according to claim 1, wherein said flexible part comprises at least one flexible lead wire electrically connecting said ear side unit and said receiver.

5. A connector according to claim 1, wherein said flexible part comprises at least one isolated wire comprising an isolating outer jacket extruded onto a number of twisted lacquered conducting wires.

6. A connector according to claim 5, wherein said isolated wire further comprises at least one strength fiber incorporated into said number of twisted lacquered conducting wires.

7. A connector according to claim 5, wherein said lacquered conducting wires comprise a number of twisted magnet wires.

8. A connector according to claim 7, wherein at least one of said twisted magnet wires are individually lacquered.

9. A connector according to claim 2, wherein said flexible part comprises at least one flexible lead wire electrically connecting said ear side unit and said receiver.

10. A connector according to claim 3, wherein said flexible part comprises at least one flexible lead wire electrically connecting said ear side unit and said receiver.

11. A connector according to claim 2, wherein said flexible part comprises at least one isolated wire comprising an isolating outer jacket extruded onto a number of twisted lacquered conducting wires.

12. A connector according to claim 3, wherein said flexible part comprises at least one isolated wire comprising an isolating outer jacket extruded onto a number of twisted lacquered conducting wires.

13. A connector according to claim 4, wherein said flexible part comprises at least one isolated wire comprising an isolating outer jacket extruded onto a number of twisted lacquered conducting wires.

14. A connector according to claim 6, wherein said lacquered conducting wires comprise a number of twisted magnet wires.
